(19) United States
(12) Patent Application Publication
(10) Pub. No.: US 2026/0065626 A1
(43) Pub. Date: Mar. 5, 2026

(54) DATA PROCESSING METHOD, APPARATUS, ELECTRONIC DEVICE, AND STORAGE MEDIUM

(71) Applicant: Lenovo (Beijing) Limited, Beijing (CN)

(72) Inventors: Maolin HUANG, Beijing (CN); Shulu GU, Beijing (CN)

(21) Appl. No.: 19/310,287

(22) Filed: Aug. 26, 2025

(30) Foreign Application Priority Data
Aug. 28, 2024 (CN) 202411195200.7

(51) Int. Cl. G06V 10/40; G06V 20/00

(52) U.S. Cl. CPC G06V 10/40; G06V 20/35; G06V 2201/07

(57) ABSTRACT

A data processing method includes: obtaining, by a first device, target data from a second device, the target data includes first information and second information; parsing, by the first device, the first information to obtain third information, the third information indicates a trustworthiness of the second device and/or a second object operating the second device and/or a scene generated by the second information; and generating, by the first device, prompt information based on the third information, in response to outputting the second information.

### RELATED APPLICATION(S)

This application claims priority to Chinese Patent Application No. 2024111952007 filed with the China National Intellectual Property Administration on Aug. 28, 2024, which is incorporated herein by reference in entirety.

### FIELD OF THE TECHNOLOGY

The present disclosure relates to a field of data processing technology, and in particular to a data processing method, apparatus, electronic device and storage medium.

### BACKGROUND

With the development of artificial intelligence, editing and synthesis of multimedia data are becoming simpler, and data content is thus more prone to tampering, leading to problems such as the spread of harmful information. How to improve the authenticity of multimedia data content to ensure the security of data dissemination is a technical problem that needs attention.

### SUMMARY

In one aspect, the present disclosure provides a data processing method. The method includes: obtaining, by a first device, target data from a second device, the target data includes first information and second information; parsing, by the first device, the first information to obtain third information, the third information indicates a trustworthiness of the second device and/or a second object operating the second device and/or a scene generated by the second information; and generating, by the first device, prompt information based on the third information, in response to outputting the second information.

In another aspect, the present disclosure provides an electronic device. The device includes: a memory storing computer program instructions; and a processor coupled to the memory and configured to execute the computer program instructions and perform: obtaining target data from a second device, the target data includes first information and second information; parsing the first information to obtain third information, the third information indicates a trustworthiness of the second device and/or a second object operating the second device and/or a scene generated by the second information; and generating prompt information based on the third information, in response to outputting the second information.

In yet another aspect, the present disclosure provides a non-transitory computer-readable storage medium storing computer program instructions executable by at least one processor to perform: obtaining, by a first device, target data from a second device, the target data includes first information and second information; parsing, by the first device, the first information to obtain third information, the third information indicates a trustworthiness of the second device and/or a second object operating the second device and/or a scene generated by the second information; and generating, by the first device, prompt information based on the third information, in response to outputting the second information.

### BRIEF DESCRIPTION OF THE DRAWINGS

Certain purposes, features and advantages of the present disclosure become clearer through the following description of certain embodiments of the present disclosure with reference to the accompanying drawings, in which:

FIG. 1 is an application scenario diagram of a data processing method, apparatus, electronic device and storage medium according to certain embodiments of the present disclosure;

FIG. 2 is a flow chart of a data processing method according to certain embodiments of the present disclosure;

FIG. 3 is a flow chart of a data processing method according to certain embodiments of the present disclosure;

FIG. 4 is a flow chart of a data processing method according to certain embodiments of the present disclosure;

FIG. 5 is a flow chart of a data processing method according to certain embodiments of the present disclosure;

FIG. 6 is a flow chart of a data processing method according to certain embodiments of the present disclosure;

FIG. 7 is a flow chart of a data processing method according to certain embodiments of the present disclosure;

FIG. 8 is a diagram of displaying prompt information on the screen of a first device according to certain embodiments of the present disclosure;

FIG. 9 is a display mode of second information and prompt information according to certain embodiments of the present disclosure;

FIG. 10 is a block diagram of a data processing apparatus according to certain embodiments of the present disclosure; and

FIG. 11 is a block diagram of an electronic device according to certain embodiments of the present disclosure.

### DETAILED DESCRIPTION

Certain embodiments of the present disclosure will be described with reference to the accompanying drawings. However, it should be understood that these descriptions are exemplary only and are not intended to limit the scope of the present disclosure. In the following detailed description, for ease of explanation, many specific details are set forth to provide a comprehensive understanding of certain embodiments of the present disclosure. However, one or more embodiments may also be implemented without these particular details. In addition, descriptions of certain well-known structures and technologies may be omitted to avoid unnecessary confusion.

The terms used herein are only for the purpose of describing certain embodiments and are not intended to limit the present disclosure. The terms “including” and “comprising” or the like are used herein to indicate the presence of the features, steps, operations and/or components, but do not exclude the presence or addition of one or more other features, steps, operations or components.

Terms (including technical and scientific terms) used herein have the meanings commonly understood by those skilled in the technical field, unless otherwise defined. The terms used herein should be interpreted as having a meaning consistent with the context of the present disclosure and should not be interpreted in an idealized or overly rigid manner.

When applicable, expressions such as “at least one of A, B, and C” should be interpreted in accordance with the meaning commonly understood by those skilled in the technical field (for example, “a system having at least one of A, B, and C” should include but is not limited to systems having A alone, B alone, C alone, A and B, A and C, B and C, and/or A, B, C, or the like).

In the technical solution of the present disclosure, the user information (including but not limited to user personal information, user image information, user device information, such as location information, or the like) and data (including but not limited to data for analysis, stored data, displayed data, or the like) involved are information and data authorized by the user or fully authorized by all parties, and the collection, storage, use, processing, transmission, provision, disclosure and implementation of the relevant data are in compliance with relevant laws, regulations and standards, necessary confidentiality measures are taken, and public order and good customs are not violated, and corresponding operation entrances are provided for users to choose to authorize or refuse.

The present disclosure in certain embodiments provides a data processing method and device. Before introducing the technical solution provided by certain embodiments of the present disclosure, the relevant technologies and scenarios involved in the present disclosure are described.

Multimedia data dissemination refers to the process of delivering information to the audience in various forms (such as text, images, audio, video, or the like) through various media and channels. For example, information is delivered to the audience through broadcasting, the audience is made aware of the form and details of things through pictures, or video content is transmitted and displayed in a seamless and real-time manner so that the audience may see the events happening in time, such as video conferencing, live broadcasting, or the like.

During the process of multimedia data dissemination, the data content may be tampered with, changing the integrity and authenticity of the original data, leading to the dissemination of bad/false content. For example, by removing, adding, and splicing the image content, the information or intention to be expressed by the original image is changed; by editing the video, inserting frames, deleting frames, tampering with the target features in the image (such as replacing the facial features of someone in the image, modifying the tone and timbre, or the like), the real content and intention to be expressed by the original video are changed.

In certain embodiments, the present disclosure obtains credible information about the data content by performing multi-dimensional detection on the received target data, and outputs prompts based on the credible information during the data dissemination process to improve the security of data dissemination.

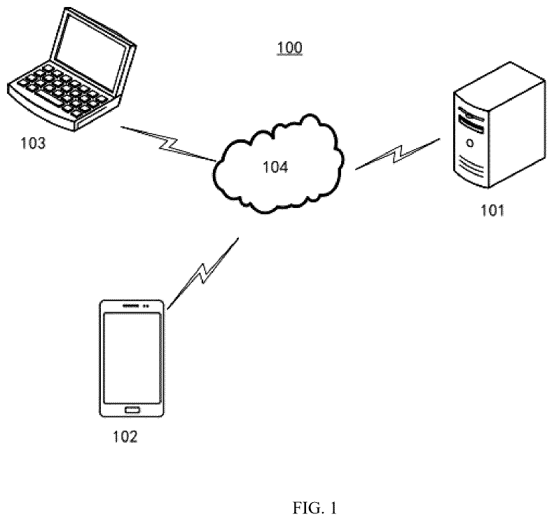

In certain embodiments, FIG. 1 is an implementation scenario diagram of a data processing method, apparatus, electronic device, and storage medium according to certain embodiments of the present disclosure.

As shown in FIG. 1, an application scenario 100 according to certain embodiments includes a first device 101, a second device 102, a second device 103, and a network 104. The network 104 is a medium for providing a communication link between the first device 101, the second device 102, and the second device 103. The network 104 may include various connection types, such as wired, wireless communication links, or optical fiber cables, or the like.

The user may use the first device 101 to interact with the second device 102 and the second device 103 through the network 104 to receive or send messages, or the like.

The second device 102 and the second device 103 may be any electronic devices with display screens and support web browsing, including but not limited to smart phones, tablet computers, laptop portable computers and desktop computers, or the like, on which various communication client applications may be installed, such as shopping applications, web browser applications, search applications, instant messaging tools, email clients, social platform software, or the like (only as examples).

In certain embodiments, the first device 101 may be an electronic device with similar functions and configurations as the second device 102 and the second device 103. The first device may be a transit device for receiving, processing and forwarding data that is different from the second device 102 and the second device 103, where the first device 101 may include, for example, a server, which may be used to analyze and process the received data sent by the second device, and feedback the processing results to the second device or other devices.

The data processing method provided in certain embodiments of the present disclosure may be executed by the first device 101. Accordingly, the data processing apparatus provided in certain embodiments of the present disclosure may be disposed in the first device 101.

The number of devices and networks in FIG. 1 is only schematic. Any number of terminal devices, networks and servers may be provided when suitable.

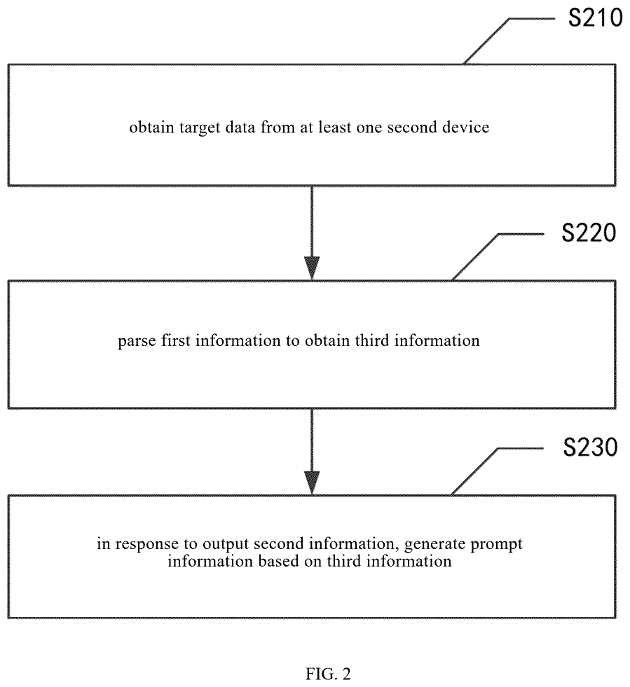

The following describes the data processing method in certain embodiments, in view of FIG. 2 to FIG. 8 based on the scenario described in FIG. 1.

FIG. 2 is a flow chart of the data processing method according to certain embodiments.

As shown in FIG. 2, the method includes operations S210 to S230.

In operation S210, target data sent by at least one second device is obtained.

In certain embodiments, the first device receives the target data sent by the second device in real time. Among them, the target data is data transmitted after being processed by the second device, and the target data corresponds to the second device one by one. In certain embodiments, the target data includes first information and second information, the first information is used to reflect the relevant attributes of the second information, and the second information includes the environment image in which the second device is located.

Taking the video conference scenario as an example, in the video conference scenario, the number of participating devices is not less than two. The first device is a device for receiving target data sent by the second device, for example, the first device may be a conference device, or a transfer device for processing and forwarding data (such as a server or platform that carries a video conference), and the second device is a conference device for sending target data. In the same video conference scenario, the first device and the second device may be converted between different conference devices, and the same conference device may be both the first device and the second device.

In operation S220, the first information is parsed to obtain the third information.

In certain embodiments, the first information in the target data is parsed, and the third information is obtained based on the parsing result of the first information. The first information contains parameters or attributes related to the second information, for example, parameters related to the content in the second information and/or parameters related to the second information generation process.

The second information may be verified for anti-counterfeiting through the first information, and the third information may be obtained based on the result of the anti-counterfeiting verification, where the third information is used to indicate the credibility of at least one of the second device, the second object operating the second device, and the second information generation scene.

In operation S230, the second information is output in response, and a prompt output is performed based on the third information.

In certain embodiments, the second information is prompted to be output based on the third information, so that the user may obtain the credibility of the second information in time while browsing the second information, effectively improving the security of information dissemination. Among them, the prompt output information may be, for example, the third information, or it may be a prompt information obtained based on the third information.

In combination with the video conferencing scenario of operation S210, when the first device is a participant device, the second information is directly output on the screen of the first device and a prompt output is performed based on the third information; when the first device is a transfer device, the first device sends the second information and the third information to the designated device, outputs the second information on the screen of the designated device, and a prompt output is performed based on the third information.

Certain embodiments of the present disclosure perform a trusted verification of the received data in multiple dimensions based on the received first information, obtains a trusted result of the data in multiple dimensions, and outputs the data based on the trusted result. Trustworthy verification of multimedia data from multiple dimensions may improve the accuracy of multimedia data anti-counterfeiting detection, and prompt output based on the trusted result while outputting the data may help users to timely understand the authenticity of the multimedia data content and improve the transparency and security of data dissemination.

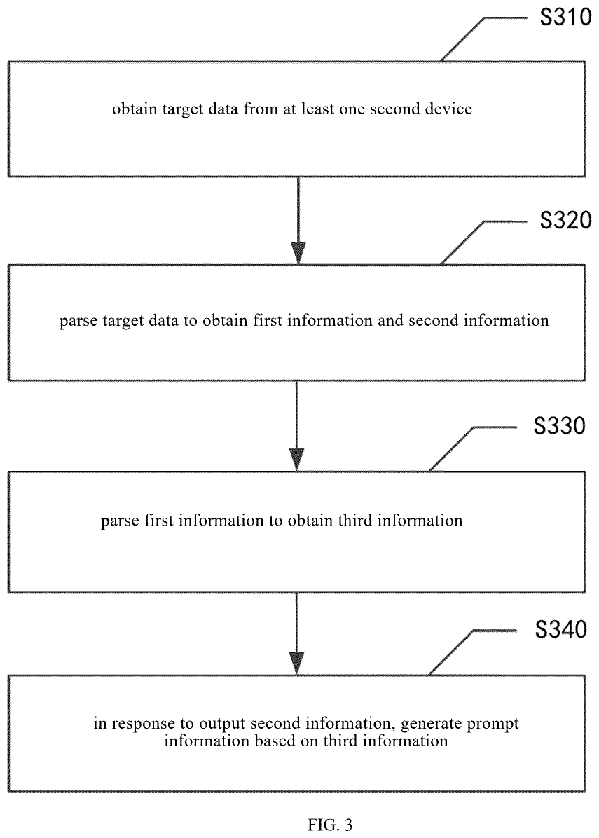

FIG. 3 is a flow chart of a data processing method according to certain embodiments of the present disclosure.

As shown in FIG. 3, in the technology of the data processing method shown in FIG. 2, the data processing method includes operations S310 to S340. Implementation details not described in the data processing method of FIG. 3 may be found in certain embodiments of the data processing method shown in FIG. 2, which are not repeated here for brevity.

In operation S310, target data sent by at least one second device is obtained.

In certain embodiments, operation S310 is the same as the operation details of operation S210 in certain embodiments of FIG. 2, which are not repeated here for brevity.

In operation S320, the target data is parsed to obtain the first information and the second information.

In certain embodiments, the first information may be stored in the target data in different forms, where the first information in different forms is obtained in different ways.

The storage form of the first information may include a first form and a second form. When the storage form of the first information is the first form, the first information is embedded in the image frame of the target data. When the storage form of the first information is the second form, the first information is used as the first data stream parameter constituting the target data.

When the first information is stored in the target data in the first form, the target data is parsed by the first method to obtain the first information and the second information. Among them, the first method may be an extraction operation corresponding to the embedding operation, and the first information and the second information may be extracted from the image frame by executing the extraction operation, and the second information is an image that does not contain the first information (for example, the image frame after the first information is extracted). The embedding operation of the first information may be, for example, digital watermark technology or steganography, and accordingly, the first method may include digital watermark extraction and steganography extraction.

In certain embodiments, steganography may include, for example, the least significant bit (LSB) steganography, discrete wavelet transform (DWT) steganography, and the like. The embedding method of LSB steganography is to embed the first information into the image frame by modifying the least significant bit of the image pixel. The first method may obtain the first information by checking and recovering the least significant bit of each pixel in the target data image frame, and use the target data image frame after extracting the first information as the second information. The embedding method of DWT steganography is to embed the first information into the wavelet coefficient of the image frame by performing wavelet transform on the image frame. The first method performs wavelet transform on the received target data image frame with the same transformation parameters, and extracts the first information from the selected wavelet coefficient to obtain the first information and the second information.

In certain embodiments, digital watermarking technology selects certain bits of pixels (such as the least significant bit LSB) or specific coefficients (such as discrete cosine transform coefficients) in the image frame as the embedding position, encodes the information to be embedded, converts it into a format suitable for embedding, and then embeds the encoded information into the image frame. The first method extracts the watermark information embedded in the image from the target data image frame through a watermark detection algorithm, and performs image restoration on the image frame at the embedded position to obtain first information and second information, where the watermark information is the first information and the restored image is the second information.

In order to ensure the security and privacy of the target data, the second device may perform an encryption operation on the first information based on the key before embedding the first information into the second information in the first form, and then embed the encrypted first information into the second information in the first form. Then the first device parses the target data in the first way, and obtains the first information and the second information include: decrypting the encrypted first information in the target data to obtain the first information. The encryption method may be, for example, symmetric encryption or asymmetric encryption.

In certain embodiments, when the first information is stored in the target data in the second form, the target data is parsed in the second way to obtain the first data stream parameter and the second data stream parameter. Among them, the second way parses the target data through the communication protocol and data format between the first device and the second device to obtain the first data stream parameter and the second data stream parameter, the first data stream parameter contains the first information, and the second information is the environmental data generated by rendering according to the second data stream parameter. When the first device receives the target data, it parses the data body according to the transmission protocol, and then parses the parameters in the data body (for example, the first data stream parameter and the second data stream parameter) according to the data format. The target data transmitted by the second device at this time is not the image itself, but the data stream parameters describing the image (for example, the second data stream parameters) are passed to the first device. After receiving the data stream parameters, the first device uses the corresponding algorithm or graphics engine to render and generate the second information according to the data stream parameters.

In operation S330, the first information is parsed to obtain the third information.

In certain embodiments, the operation details of operation S330 are the same as those of operation S220 in certain embodiments of FIG. 2, and are not repeated here for brevity.

In operation S340, the second information is output in response, and a prompt output is performed based on the third information.

In certain embodiments, the operation details of operation S340 are the same as those of operation S220 in certain embodiments of FIG. 2, and are not repeated here for brevity.

Certain embodiments of the present disclosure obtain the first information and the second information by parsing the target data. The first information may help the first device trace back to the original generation scene, generation device and original content of the second information, and help the first device quickly determine the credibility of the second information through the first information, thereby improving the accuracy and efficiency of determining the credibility of the second information. Storing the first information in the target data in the first form may improve the concealment of the first information without causing additional transmission burden. Storing the first information in the target data in the second form may improve the flexibility and controllability of the first information. Those skilled in the art may choose the storage method of the first information according to particular conditions, and the present disclosure does not limit as to the particular type of storage method.

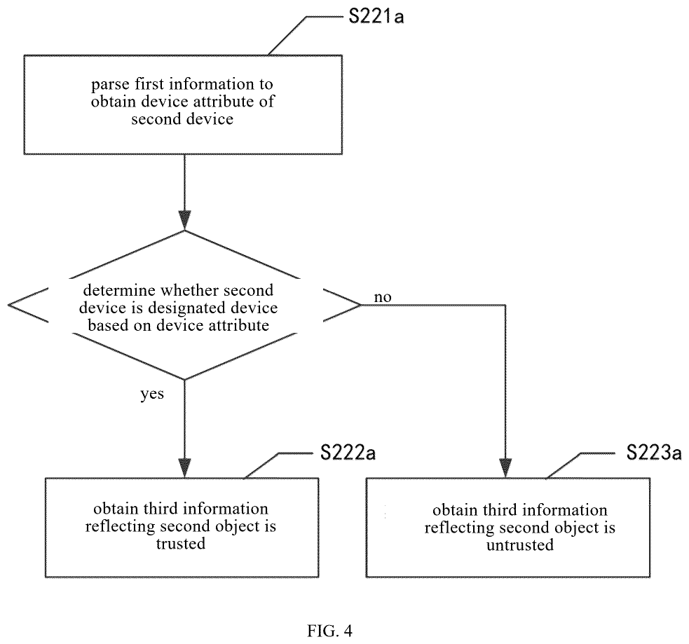

FIG. 4 is a flow chart of a data processing method according to certain embodiments of the present disclosure.

As shown in FIG. 4, in the technology of the data processing method shown in FIG. 2, operation S220 in the data processing method may further include operations S221a to S223a. Other implementation details not described in the data processing method of FIG. 4 but described in FIG. 2, are not repeated here for brevity.

In operation S221a, the first information is parsed to obtain the attribute or parameter information of the second device.

In certain embodiments, the first information is parsed to obtain the attribute information or device attribute of the second device. The attribute information of the second device may include, for example, the device name, serial number, access location, or the like of the second device.

In operation S222a, when the attribute information indicates that the second device is a designated device, the third information reflecting that the second device is a trusted device is obtained.

In operation S223a, when the attribute information indicates that the second device is a non-designated device, the third information reflecting that the second device is an untrusted device is obtained.

In certain embodiments, after obtaining the attribute information of the second device, the attribute information of the second device is analyzed based on the reference device information to determine whether the second device is a designated device, and the corresponding third information is obtained based on the analysis result. The reference device information may be reserved device attribute information and/or historical device attribute information. The reserved device attribute information may be the attribute information registered when the account is first registered, or the attribute information modified by the account after verification. The historical device attribute information may be the attribute information of commonly used devices determined based on the historical usage of the account.

Based on the historical device attribute information and/or the reserved device attribute information, the second device corresponding to the target data is verified to obtain the third information used to characterize the credibility of the second device. For example, it is determined whether the device name and serial number of the second device attribute information are consistent with the designated device/common device in the reserved device attribute information and/or the historical device attribute information, and the use of the device is determined; it is determined whether the access location of the second device is consistent with the access location in the reserved device attribute information and/or the historical device attribute information, where the access location may further include a physical location, a network interface location, a logical location, etc.

Based on the verification result, the corresponding third information is obtained. When the verification result is that the verification is passed (that is, the attribute information characterizes that the second device is a designated device), the third information reflecting that the second device is a trusted device is obtained. When the verification result is that the verification is not passed (that is, the attribute information characterizes that the second device is not a designated device), the third information reflecting that the second device is an untrusted device is obtained.

In certain embodiments, the present disclosure verifies the credibility of the second device to ensure that the source of the second information is credible, thereby quickly judging the authenticity of the data content. Trusted devices usually have higher security and stability. Therefore, when the attribute information characterizes that the second device is a designated device, the third information reflecting that the second device is a trusted device is obtained. In addition, by verifying whether the second device is a designated device, it may also ensure that the data content has not been illegally or otherwise improperly tampered with or replaced during the transmission process, reducing the security risk of the second information.

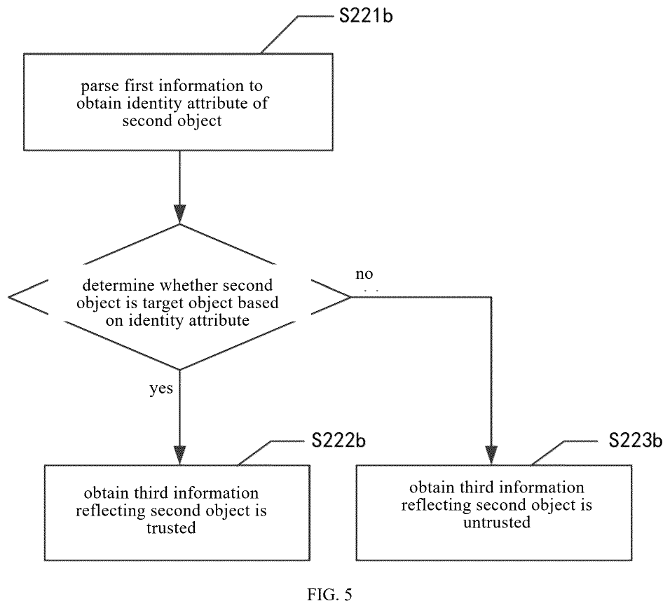

FIG. 5 is a flow chart of a data processing method according to certain embodiments of the present disclosure.

As shown in FIG. 5, in view of the data processing method shown in FIG. 2, operation S220 in the data processing method of FIG. 5 may further include operation S221b to operation S223b. Other implementation details not described in the data processing method of FIG. 5 may be found in certain embodiments of the data processing method shown in FIG. 2, which are not repeated for brevity.

In operation S221b, the first information is parsed to obtain the identity attribute of the second object.

In certain embodiments, the first information is parsed to obtain the identity attribute of the second object, where the second object is the object that is operating the second device. The identity attribute is used to characterize the identity information and/or identity characteristics of the second object, and may include, for example, the personal image, personal information, or the like of the second object.

The personal image may include, for example, a reserved avatar of the second object (such as a real-name registered avatar), and the personal information may include, for example, the identity identifier of the second object, so that the first device may obtain reference feature information of the second object based on the identity identifier, or may directly include the reference feature information of the second object. The reference feature information includes facial information, audio information, posture information, etc. of the second object, and the feature information may be presented in the form of digital coding. The reference feature information may be, for example, a security verification feature reserved during account registration, or feature information determined based on its historical image.

In operation S222b, when the identity attribute characterizes that the second object is a target object, third information reflecting that the second object is a trusted object is obtained.

In operation S223b, when the identity attribute characterizes that the second object is not a target object, third information reflecting that the second object is an untrusted object is obtained.

In certain embodiments, after obtaining the identity attribute of the second object, the second object in the second information is identified based on the identity attribute, and it is determined whether the second object is a target object.

In certain embodiments, identifying the second object in the second information based on the identity attribute includes: extracting the target feature of the second object from the second information; identifying the target feature based on the identity attribute, and obtaining the recognition result of the second object.

In certain embodiments, the target feature of the second object extracted from the second information may include, for example, the facial feature, posture feature, audio feature, or the like of the second object.

Identifying the target feature based on the identity attribute includes: identifying each target feature based on the identity attribute, and obtaining the recognition result of each target feature; and/or, selecting at least two target features from multiple target features for combination, obtaining at least one target feature group, identifying the target feature group based on the identity attribute, and obtaining the recognition result of the target feature group.

In certain embodiments, facial features may include, for example, multiple feature points (such as the position and shape of eyes, nose, mouth, or the like), posture features may include, for example, static postures (such as joint positions, body directions, user movements, or the like) and/or dynamic postures (user posture changes), and audio features may include, for example, frequency, timbre, intonation, or the like.

In certain embodiments, based on the identity attribute, each target feature is identified separately to obtain the identification result of each target feature, including: comparing the facial information in the reference feature information with the current facial feature in the target feature to obtain the identification result of the facial feature. Comparing the current posture feature with the posture information in the reference feature information, determining whether the second object appears in a posture and/or whether abnormal behavior occurs, and obtaining the identification result of the posture feature. Comparing the current audio feature with the audio information in the reference feature information, obtaining the identification result of the audio feature of the second object.

In certain embodiments, selecting at least two target features from multiple target features for combination to obtain at least one target feature group, identifying the target feature group based on the identity attribute, may include: fusing the selected multiple target features to obtain an integrated feature; identifying the integrated feature based on the reference feature information. In certain embodiments, the integrated feature combines the information of multiple single features, which helps to capture the complex features of the second object, and because different single features often contain different information, by fusing the single features, the complementary advantages between the single features may be utilized to better describe the second object, which helps to more accurately identify the second object. In certain embodiments, multimodal features may be fused by means of feature vector splicing, attention mechanism, or the like to obtain a combined or integrated feature.

Taking the selected target features as facial features and audio features and the feature fusion method as the attention mechanism as an example, the process of obtaining the integrated features is illustrated: the weight matrices corresponding to the facial features and audio features are obtained respectively; the weight matrices are multiplied by the corresponding feature vectors to obtain the weighted feature vectors; the weighted feature vectors are processed using the attention gating mechanism to further adjust the weight of each feature; the weighted audio feature vectors and face feature vectors that have been processed by the attention gating are concatenated to obtain the integrated features.

In certain embodiments, the splicing operation may retain the original information of the two modal features (for example, audio features and facial features) so as to utilize the original information in the subsequent recognition process. That is to say, in the process of identifying the integrated features based on the reference feature information, in addition to identifying the integrated features, the single features in the feature combination may also be identified, and the recognition result of the target feature group is determined based on the integrated features and the single features.

In certain embodiments, the target features are identified based on the identity attributes to obtain the recognition result of the second object, including: jointly determining the recognition result of the second object based on the recognition results of each target feature/target feature group.

When the recognition result of the second object indicates that the second object is the target object, the third information reflecting that the second object is a credible object is obtained. When the recognition result indicates that the second object is not the target object, the third information reflecting that the target object is an untrusted object is obtained.

In certain embodiments, the identity attribute in the first information is the identity attribute determined by the second device after performing portrait detection and recognition on the second object in the original information. The original information is the information directly captured by the camera of the second device. The second device determines the identity attribute of the second object based on the original information, for example, including: performing a portrait detection and recognition operation on the original information to obtain the portrait information and identity information of the second object.

Certain embodiments of the present disclosure determine whether the second object is the target object from multiple feature dimensions based on the identity attribute of the second object, which may evaluate the credibility of the second object in the second information, avoid the forgery of the target object, and improve the comprehensiveness and accuracy of the anti-counterfeiting verification of the second object, thereby maintaining the authenticity and security of the video content.

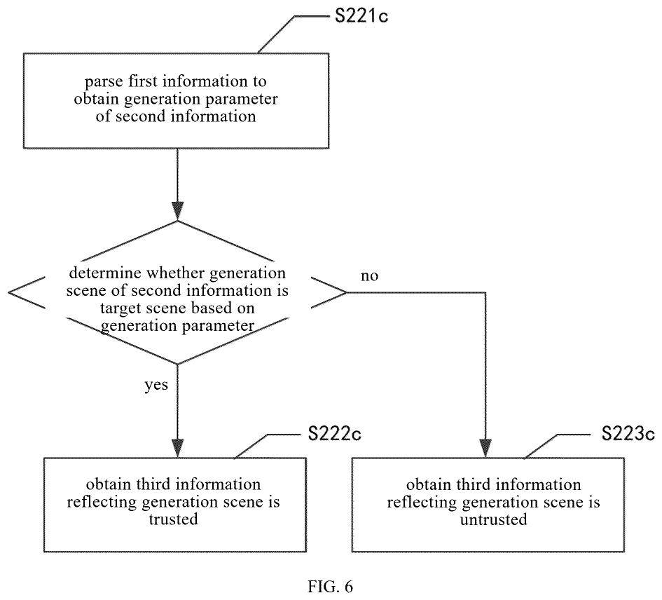

FIG. 6 is a flow chart of a data processing method according to certain embodiments of the present disclosure.

As shown in FIG. 6, in the technology of the data processing method shown in FIG. 2, operation S220 in the data processing method of FIG. 6 may further include operations S221c to operation S223c. Other implementation details not described in the data processing method of FIG. 6 may be found in the data processing method shown in FIG. 2, which are not repeated here for brevity.

In operation S221c, the first information is parsed to obtain the generation parameters of the second information.

In certain embodiments, the generation parameters of the second information may include, for example, information related to the generation scenario of the second information, and whether the second information is generated in the target scenario is determined by the generation parameters.

Taking the online video conference scenario as an example, the generation parameters of the second information may include, for example, the conference theme, the conference initiator, the conference serial number, or the like.

In operation S222c, when the generation scenario of the second information represented by the generation parameter is the target scenario, third information reflecting that the generation scenario is a credible or trusted scenario is obtained.

In operation S223c, when the generation scenario of the second information represented by the generation parameter is not the target scenario, third information reflecting that the generation scenario is an untrusted scenario is obtained.

In certain embodiments, the first device identifies the generation parameters of the second information based on the current scene information, and determines whether the generation scene of the second information is consistent with the current scene. When the generation scene of the second information is consistent with the current scene, the generation scene of the second information is determined to be the target scene, and the third information reflecting that the generation scene is a credible or trusted scene is obtained. When the generation scene of the second information is inconsistent with the current scene, it is determined that the generation scene of the second information is not the target scene, and the third information reflecting that the generation scene is an untrusted scene is obtained.

Taking the online video conference scene as an example, the current scene information of the meeting where the first device is located includes: meeting theme—xxx mid-year summary meeting, meeting initiator—Wang Moumou, meeting serial number—2485923. Compare the current scene information with the generation parameters of the second information. When the generation parameters of the second information are consistent with the current scene information, the generation scene of the second information is determined to be a credible or trusted scene. When the generation parameters of the second information are inconsistent with the current scene information, it means that the second information is not generated in the current video conference scene, and the generation scene of the second information is determined to be an untrusted scene.

The generation parameter of the second information is the information given to the second information during the generation process, which is unique and identifiable. Certain embodiments of the present disclosure determine the generation scenario of the second information based on the generation parameter of the second information, which may prevent the second information from being impersonated or incorrectly associated. The generation scenario may reflect the credibility of the second information content to a certain extent and maintain the authenticity and security of the currently transmitted data content.

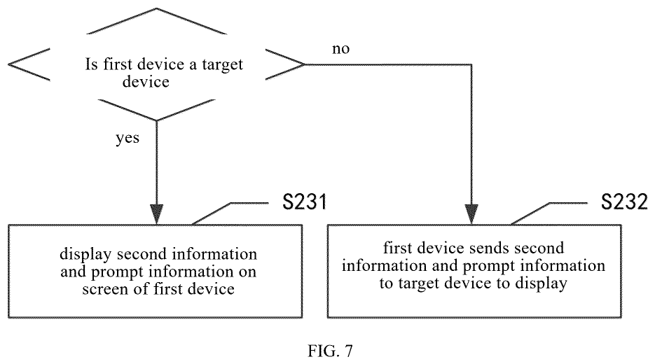

FIG. 7 is a flow chart of a data processing method according to certain embodiments of the present disclosure.

As shown in FIG. 7, in the technology of the data processing method shown in FIG. 2, operation S230 in the data processing method of FIG. 7 may further include operation S231 to operation S232. Other implementation details not described in the data processing method of FIG. 7 may be found in the data processing method shown in FIG. 2, which are not repeated here for brevity.

In operation S231, when the first device is the target device, the second information and the prompt information are displayed on the screen of the first device.

In certain embodiments, the target device is a device with a display screen that may directly display the second information, such as a mobile phone, a tablet, a computer, or the like. When the first device is the target screen, the second information and the prompt information may be directly displayed on the screen of the first device.

The prompt information is the third information and/or the comprehensive information processed based on the third information. For example, the credibility of the second device and/or the second object of the second device and/or the second information generation scene is analyzed by preset weights to obtain comprehensive information for indicating the credibility of the second information.

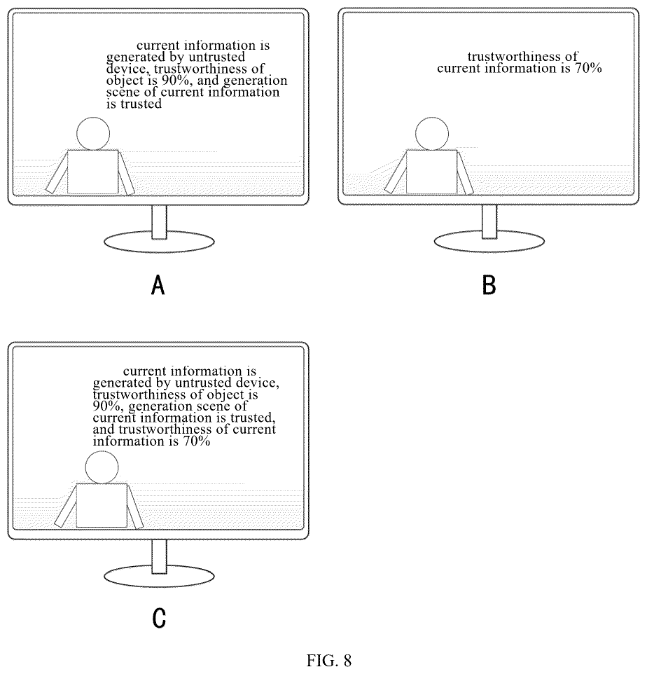

FIG. 8 is a diagram of displaying prompt information on the screen of the first device according to certain embodiments of the present disclosure.

As shown in FIG. 8, the prompt information is displayed on the screen of the first device, and the third information used to indicate the credibility of the second device and/or the second object of the second device and/or the second information generation scene may be displayed as prompt information (see FIG. 8A). The comprehensive information obtained based on the third information to reflect the credibility of the second information may also be displayed as prompt information (see FIG. 8B). The third information and the comprehensive information may also be displayed together as prompt information (see FIG. 8C).

In certain embodiments, the second information and the prompt information are displayed on the screen of the first device, including: displaying the prompt information superimposed on the second information; or, displaying the second information and the prompt information in different areas of the screen.

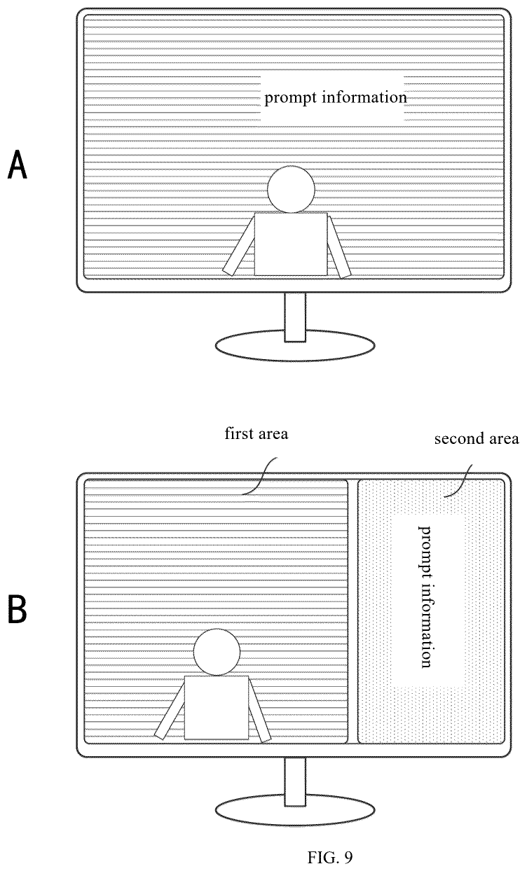

FIG. 9 is the display mode of the second information and the prompt information according to certain embodiments of the present disclosure. As shown in FIG. 9A, the prompt information is superimposed on the second information for display. As shown in FIG. 9B, the second information and the prompt information are displayed in different areas of the screen.

In certain embodiments, superimposing the prompt information on the second information for display may include, for example: embedding the prompt information into the second information and displaying the embedded information on the screen, or, while displaying the second information, superimposing the prompt information on the screen of the second information in real time. Embedding the prompt information into the second information helps to improve the persistence of the prompt effect. The prompt information embedded into the second information becomes a part of the video content. Even when the video is copied and disseminated, the prompt information is retained and difficult to be removed or tampered with. It may be applied to the second information with a lower degree of credibility. While displaying the second information, superimposing the prompt information on the screen of the second information in real time has high flexibility and may be adjusted according to the playback scene and screen changes, and the real-time superposition does not change the original data of the second information.

As shown in FIG. 9B, the screen may include, for example, a first area for displaying the second information and a second area for displaying the prompt information, and the layout and size of the first area and the second area may be adjusted in real time based on viewing habits. Displaying the prompt information and the second information in a split screen helps the user to focus on the video content and the prompt information at the same time, while avoiding excessive interference of the prompt information on the content of the second information, so that the user may focus more on the second information itself.

In certain embodiments, the display mode of the second information and the prompt information may be selected according to particular conditions, and the present disclosure does not cast limit on the type of the display mode.

In operation S232, when the first device is a transfer device, the first device sends the second information and the prompt information to the target device for display.

In certain embodiments, the transfer device is used to process and forward the received data, and the transfer device itself does not have a display screen in a physical sense. For example, it may include a conference cloud, an application platform processor, or the like.

When the first device is a transfer device, the first device sends the first information and the prompt information to the target device to display the first information and the prompt information on the screen of the target device. In certain embodiments, displaying the first information and the prompt information on the screen of the target device includes: displaying the prompt information superimposed on the second information; or, displaying the second information and the prompt information in different areas of the screen.

In certain embodiments, displaying the prompt information superimposed on the second information may include, for example: embedding the prompt information into the second information and displaying the embedded information on the screen, or, while displaying the second information, superimposing the prompt information on the screen of the second information in real time.

Corresponding to different display modes, the data format sent by the first device to the target device may also be different. For example, when the prompt information is embedded in the second information for display, the first device edits the embedded information and the second device to embed the prompt information into the second information, and sends the embedded second information as a file to the target device. When the prompt information is to be superimposed on the screen of the second information in real time for display, the first device sends corresponding control instructions to the target device while sending the prompt information and the second information to the target device, so that the target device may realize the real-time superposition of the prompt information.

Certain embodiments of the present disclosure display the second information and the prompt information on the screen of the target device, so that the viewing object or a user sitting in front of the screen of the first device may timely understand the credibility and authenticity of the information, so as to improve the transparency of information dissemination, promote the true dissemination of information, and improve the security of multimedia data dissemination.

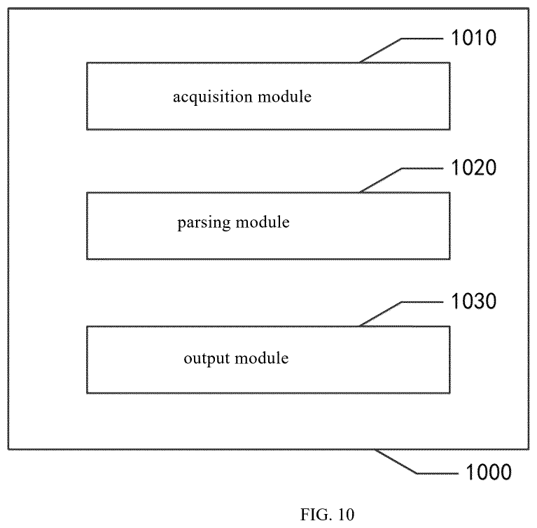

FIG. 10 is a block diagram of a data processing device according to certain embodiments of the present disclosure.

As shown in FIG. 10, the data processing device 1000 includes an acquisition module 1010, a parsing module 1020, and an output module 1030.

The acquisition module 1010 is used to obtain target data sent by at least one second device; the target data corresponds to the second device one by one, and the target data includes first information and second information, and the second information includes an image of the environment in which the second device is located. The acquisition module 1010 may be used to perform the operation S210 described above, the description of which is not repeated here for brevity.

The parsing module 1020 is used to parse the first information and obtain the third information; the third information is used to indicate the credibility or trustworthiness of the second device and/or the second object and/or the second information generation scene of the second device. In certain embodiments, the parsing module 1020 may be used to perform the operation S220 described above, the content of which is not repeated here for brevity.

The output module 1030 is used to respond to the output of the second information and to output a prompt based on the third information. In certain embodiments, the output module 1030 may be used to perform the operation S230 described above, the description of which is not repeated here for brevity.

According to certain embodiments of the present disclosure, any one or more of the modules, sub-modules, units, and sub-units, or at least part of the functions of any one or more of them may be implemented in one module. According to certain embodiments of the present disclosure, any one or more of the modules, sub-modules, units, and sub-units may be split into multiple modules for implementation. According to certain embodiments of the present invention, any one or more of the modules, submodules, units, and subunits may be at least partially implemented as hardware circuits, such as field programmable gate arrays (FPGAs), programmable logic arrays (PLAs), systems on chips, systems on substrates, systems on packages, application-specific integrated circuits (ASICs), or may be implemented by hardware or firmware in any other reasonable way of integrating or packaging circuits, or may be implemented in any one of the three implementation methods of software, hardware, and firmware, or in an appropriate combination of any of them. Alternatively, according to certain embodiments of the present invention, one or more of the modules, submodules, units, and subunits may be at least partially implemented as computer program modules, which may perform corresponding functions when the computer program modules are run.

In certain embodiments, any multiple of the acquisition module 1010, the parsing module 1020, and the output module 1030 may be combined in one module/unit/sub-unit for implementation, or any one of the modules/units/sub-units may be split into multiple modules/units/sub-units. In certain embodiments, at least part of the functions of one or more of these modules/units/sub-units may be combined with at least part of the functions of other modules/units/sub-units and implemented in one module/unit/sub-unit. According to certain embodiments of the present disclosure, at least one of the acquisition module 1010, the parsing module 1020, and the output module 1030 may be at least partially implemented as a hardware circuit, such as a field programmable gate array (FPGA), a programmable logic array (PLA), a system on a chip, a system on a substrate, a system on a package, an application specific integrated circuit (ASIC), or may be implemented by hardware or firmware such as any other reasonable way of integrating or packaging the circuit, or implemented in any one of the three implementation methods of software, hardware, and firmware or in a suitable combination of any of them. In certain embodiments, at least one of the acquisition module 1010, the parsing module 1020, and the output module 1030 may be at least partially implemented as a computer program module, and when the computer program module is run, the corresponding function may be executed.

The data processing system part in certain embodiments of the present disclosure corresponds to the data processing method part in certain embodiments of the present disclosure, and the description of the data processing system part may be found with reference to the data processing method part, description of which is not repeated here for brevity.

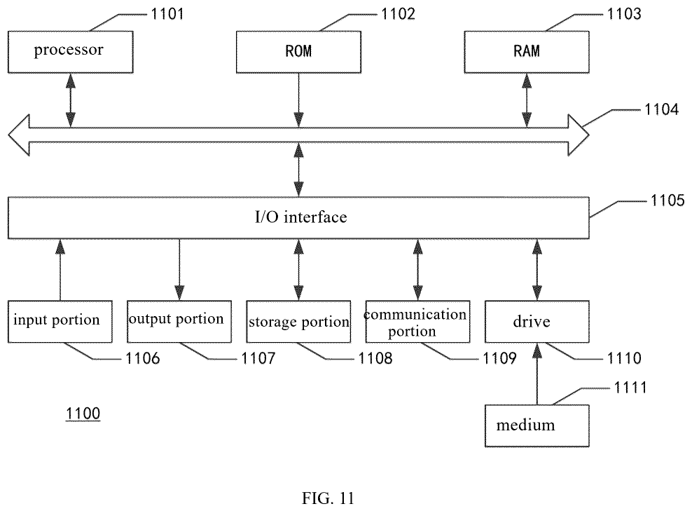

FIG. 11 is a block diagram of an electronic device suitable for implementing the data processing method of certain embodiments of the present disclosure according to certain embodiments of the present disclosure. The electronic device shown in FIG. 11 is only an example and should not bring any limitation to the function and scope of use of certain embodiments of the present disclosure.

As shown in FIG. 11, the electronic device 1100 according to certain embodiments of the present disclosure includes a processor 1101, which may perform various appropriate actions and processes according to a program stored in a read-only memory (ROM) 1102 or a program loaded from a storage portion 1108 to a random access memory (RAM) 1103. The processor 1101 may include, for example, a general-purpose microprocessor (for example, a CPU), an instruction set processor and/or a related chipset and/or a special-purpose microprocessor (e.g., an application-specific integrated circuit (ASIC)), or the like. The processor 1101 may also include an onboard memory for cache purposes. The processor 1101 may include a single processing unit or multiple processing units for executing different actions of the method flow according to certain embodiments of the present disclosure.

In RAM 1103, various programs and data required for the operation of electronic device 1100 are stored. Processor 1101, ROM 1102 and RAM 1103 are connected to each other through bus 1104. Processor 1101 performs various operations of the method flow according to certain embodiments of the present disclosure by executing the program in ROM 1102 and/or RAM 1103. It should be noted that the program may also be stored in one or more memories other than ROM 1102 and RAM 1103. Processor 1101 may also perform various operations of the method flow according to certain embodiments of the present disclosure by executing the program stored in the one or more memories.

According to certain embodiments of the present disclosure, electronic device 1100 may also include an input/output (I/O) interface 1105, which is also connected to bus 1104. The electronic device 1100 may also include one or more of the following components connected to the input/output (I/O) interface 1105: an input portion 1106 including a keyboard, a mouse, or the like; an output portion 1107 including a cathode ray tube (CRT), a liquid crystal display (LCD), or the like, and a speaker, or the like; a storage portion 1108 including a hard disk, or the like; and a communication portion 1109 including a network interface card such as a LAN card, a modem, or the like. The communication portion 1109 performs communication processing via a network such as the Internet. The drive 1110 is also connected to the input/output (I/O) interface 1105 as needed. A removable medium 1111, such as a magnetic disk, an optical disk, a magneto-optical disk, a semiconductor memory, or the like, is installed on the drive 1110 as needed, so that a computer program read therefrom is installed into the storage portion 1108 as needed.

According to certain embodiments of the present disclosure, the method according to certain embodiments of the present disclosure may be implemented as a computer software program. For example, certain embodiments of the present disclosure include a computer program product, which includes a computer program carried on a computer-readable storage medium, and the computer program includes a program code for executing the method shown in the flowchart. In such certain embodiments, the computer program may be downloaded and installed from the network through the communication portion 1109, and/or installed from the removable medium 1111. When the computer program is executed by the processor 1101, the above-mentioned functions defined in the system of certain embodiments of the present disclosure are executed. According to certain embodiments of the present disclosure, the system, device, apparatus, module, unit, etc. described above may be implemented by a computer program module.

The present disclosure in certain embodiments provides a computer-readable storage medium, which may be included in the device/device/system described in the above embodiment; or it may exist alone without being assembled into the device/device/system. The above-mentioned computer-readable storage medium carries one or more programs, and when the above-mentioned one or more programs are executed, the method according to certain embodiments of the present disclosure is implemented.

According to certain embodiments of the present disclosure, the computer-readable storage medium may be a non-volatile computer-readable storage medium. For example, it may include but is not limited to: a portable computer disk, a hard disk, a random access memory (RAM), a read-only memory (ROM), an erasable programmable read-only memory (EPROM or flash memory), a portable compact disk read-only memory (CD-ROM), an optical storage device, a magnetic storage device, or any suitable combination of the above. In the present disclosure, a computer-readable storage medium may be any tangible medium containing or storing a program, which may be used by or in combination with an instruction execution system, an apparatus or a device.

For example, according to certain embodiments of the present disclosure, the computer-readable storage medium may include the ROM 1102 and/or RAM 1103 described above and/or one or more memories other than ROM 1102 and RAM 1103.

Certain embodiments of the present disclosure also includes a computer program product, which includes a computer program, the computer program including a program code for executing the method provided by certain embodiments of the present disclosure, and when the computer program product is run on an electronic device, the program code is used to enable the electronic device to implement the data processing method provided by certain embodiments of the present disclosure.

When the computer program is executed by the processor 1101, the above functions defined in the system/device of certain embodiments of the present disclosure are executed. According to certain embodiments of the present disclosure, the system, device, module, unit, or the like, described above may be implemented by a computer program module.

In certain embodiments, the computer program may rely on tangible storage media such as optical storage devices and magnetic storage devices. In certain embodiments, the computer program may also be transmitted and distributed in the form of signals on a network medium, and downloaded and installed through the communication portion 1109, and/or installed from a removable medium 1111. The program code contained in the computer program may be transmitted using any appropriate network medium, including but not limited to: wireless, wired, etc., or any suitable combination of the above.

According to certain embodiments of the present disclosure, the program code for executing the computer program provided by certain embodiments of the present disclosure may be written in any combination of one or more programming languages. These computer programs may be implemented using high-level procedural and/or object-oriented programming languages, and/or assembly/machine languages. Programming languages include but are not limited to programming languages such as Java, C++, python, “C” language, or similar programming languages. The program code may be executed entirely on a user computing device, partially on a user device, partially on a remote computing device, or entirely on a remote computing device or server. Where a remote computing device is involved, the remote computing device may be connected to the user computing device through any type of network, including a local area network (LAN) or a wide area network (WAN), or may be connected to an external computing device (for example, through the Internet using an Internet service provider).

The flowcharts and block diagrams in the accompanying drawings illustrate the possible implementation architecture, functions and operations of the systems, methods and computer program products according to various embodiments of the present disclosure. In this regard, each box in the flowchart or block diagram may represent a module, a program segment, or a part of a code, and the above-mentioned module, program segment, or a part of the code contains one or more executable instructions for implementing the specified logical function. In certain embodiments, the functions marked in the box may also occur in an order different from that marked in the accompanying drawings. For example, two boxes represented in succession may be executed substantially in parallel, and they may sometimes be executed in the opposite order, depending on the functions involved. In certain embodiments, each box in the block diagram or flowchart, and the combination of boxes in the block diagram or flowchart, may be implemented with a dedicated hardware-based system that performs a function or operation, or may be implemented with a combination of dedicated hardware and computer instructions. In certain embodiments, the features recorded in the various embodiments of the present disclosure may be combined and/or combined in a variety of ways, even when such a combination or combination is not explicitly recorded in the present disclosure. In particular, without departing from the spirit and teachings of the present disclosure, the features described in the various embodiments of the present disclosure may be combined and/or combined in various ways. These combinations and/or combinations fall within the scope of the present disclosure.

Certain embodiments of the present disclosure are described above. However, these embodiments are for illustrative purposes only and are not intended to limit the scope of the present disclosure. Certain embodiments as described above may be combined to be used in combination. Without departing from the scope of the present disclosure, a person skilled in the technical field may make various substitutions and modifications, which should fall within the scope of the present disclosure.

What is claimed is:

1. A data processing method, comprising:
obtaining, by a first device, target data from a second device, the target data includes first information and second information;
parsing, by the first device, the first information to obtain third information, the third information indicates a trustworthiness of the second device and/or a second object operating the second device and/or a scene generated by the second information; and
generating, by the first device, prompt information based on the third information, in response to outputting the second information.

2. The data processing method of claim 1, further comprising:
when the first information is stored in the target data in a first form, parsing the target data in a first way to obtain the first information and the second information; or
when the first information is stored in the target data in a second form different from the first form, parsing the target data in a second way to obtain the first information and the second information, the second way being different from the first way.

3. The data processing method of claim 1, wherein parsing of the first information to obtain the third information includes:
parsing the first information to obtain a device attribute of the second device; and
when the device attribute indicates that the second device is a designated device, obtaining the third information reflecting that the second device is a trusted device; or
when the device attribute indicates that the second device is not the designated device, obtaining the third information reflecting that the second device is an untrusted device.

4. The data processing method of claim 1, wherein parsing of the first information to obtain the third information includes:
parsing the first information to obtain an identity attribute of the second object; and
when the identity attribute indicates that the second object is a target object, obtaining the third information reflecting that the second object is a trusted object; or
when the identity attribute indicates that the second object is not a target object, obtaining the third information reflecting that the second object is an untrusted object.

5. The data processing method of claim 1, wherein parsing of the first information to obtain the third information includes:
parsing the first information to obtain a generation parameter of the second information; and
when a generation scenario of the second information represented by the generation parameter is a target scenario, obtaining the third information reflecting that the generation scenario is a trusted scenario; or
when the generation scenario of the second information represented by the generation parameter is not the target scenario, obtaining the third information reflecting that the generation scenario is an untrusted scenario.

6. The data processing method of claim 1, further comprising:
when the first device is a target device, displaying the second information and prompt information on a screen of the first device; or
when the first device is a transfer device, sending by the first device the second information and prompt information to the target device for display.

7. The data processing method of claim 6, wherein displaying of the second information and the prompt information on the screen of the first device includes:
displaying the prompt information on top of the second information; or
displaying the second information and the prompt information in different areas of the screen.

8. The data processing method of claim 1, wherein the second device is a first second device and the target data is first target data, and the method further comprises:
obtaining, by the first device, second target data from a second device different from the first second device.

9. The data processing method of claim 1, wherein the second information includes an image of an environment in which the second device is located.

10. The data processing method of claim 2, wherein in the first form, the first information is embedded in an image frame of the target data.

11. An electronic device, comprising: a memory storing computer program instructions; and a processor coupled to the memory and configured to execute the computer program instructions and perform:
obtaining target data from a second device, the target data includes first information and second information;
parsing the first information to obtain third information, the third information indicates a trustworthiness of the second device and/or a second object operating the second device and/or a scene generated by the second information; and
generating prompt information based on the third information, in response to outputting the second information.

12. The electronic device of claim 11, wherein the processor is further configured to perform:
when the first information is stored in the target data in a first form, parsing the target data in a first way to obtain the first information and the second information; or
when the first information is stored in the target data in a second form different from the first form, parsing the target data in a second way to obtain the first information and the second information, the second way being different from the first way.

13. The electronic device of claim 11, wherein parsing of the first information to obtain the third information includes:
parsing the first information to obtain a device attribute of the second device; and
when the device attribute indicates that the second device is a designated device, obtaining the third information reflecting that the second device is a trusted device; or
when the device attribute indicates that the second device is not the designated device, obtaining the third information reflecting that the second device is an untrusted device.

14. The electronic device of claim 11, wherein parsing of the first information to obtain the third information includes:
parsing the first information to obtain an identity attribute of the second object; and
when the identity attribute indicates that the second object is a target object, obtaining the third information reflecting that the second object is a trusted object; or
when the identity attribute indicates that the second object is not a target object, obtaining the third information reflecting that the second object is an untrusted object.

15. The electronic device of claim 11, wherein parsing of the first information to obtain the third information includes:
parsing the first information to obtain a generation parameter of the second information; and
when a generation scenario of the second information represented by the generation parameter is a target scenario, obtaining the third information reflecting that the generation scenario is a trusted scenario; or
when the generation scenario of the second information represented by the generation parameter is not the target scenario, obtaining the third information reflecting that the generation scenario is an untrusted scenario.

16. The electronic device of claim 11, wherein the processor is further configured to perform:
when the electronic device is a target device, displaying the second information and prompt information on a screen of the electronic device; or
when the electronic device is a transfer device, sending the second information and prompt information to the target device for display.

17. The electronic device of claim 16, wherein displaying of the second information and the prompt information on the screen of the first device includes:
displaying the prompt information on top of the second information; or
displaying the second information and the prompt information in different areas of the screen.

18. The electronic device of claim 11, wherein the second device is a first second device and the target data is first target data, and the wherein the processor is further configured to perform:
obtaining second target data from a second device different from the first second device.

19. The electronic device of claim 11, wherein the second information includes an image of an environment in which the second device is located.

20. A non-transitory computer-readable storage medium storing computer program instructions executable by at least one processor to perform:
obtaining, by a first device, target data from a second device, the target data includes first information and second information;
parsing, by the first device, the first information to obtain third information, the third information indicates a trustworthiness of the second device and/or a second object operating the second device and/or a scene generated by the second information; and
generating, by the first device, prompt information based on the third information, in response to outputting the second information.
